(19) United States
(12) Patent Application Publication
(10) Pub. No.: US 2024/0258539 A1
(43) Pub. Date: Aug. 1, 2024

(54) NETWORK OF OPTICAL FIBER SENSORS AND METHOD FOR MONITORING THE STRUCTURAL HEALTH OF A COMPOSITE CRYOGENIC LIQUID HYDROGEN FUEL TANK

(71) Applicant: AIRBUS OPERATIONS, S.L.U., Getafe (ES)

(72) Inventor: Carlos DE MIGUEL GIRALDO, Getafe (ES)

(21) Appl. No.: 18/508,620

(22) Filed: Nov. 14, 2023

(30) Foreign Application Priority Data
Feb. 1, 2023 (EP) 23382085.1

(51) Int. Cl. H01M 8/04082; H01M 8/0432; H01M 8/0438; H01M 8/0444; H01M 8/2475

(52) U.S. Cl. CPC H01M 8/04208; H01M 8/04365; H01M 8/0438; H01M 8/0444; H01M 8/2475

(57) ABSTRACT

A network of optical fiber sensors and method for monitoring the structural health of a composite cryogenic liquid hydrogen fuel tank (1), wherein the method includes: determination of the permeability curves k=f(t) for a material configuration as a function of service conditions, and determination of the critical k value for the material configuration, real in-service testing for the tank (1) with a specific material configuration; continuous measurement of parameters by a network of optical fiber sensors in the tank including wherein the parameters are one or more of a temperature distribution in the tank, strain in locations in the tank, and pressure in the tank, analysis of the evolution and correlations of the measured parameters along in-service time; and determination of the threshold level of micro-cracks, estimation of the permeability status of the tank (1), comparing k with the critical k value.

### RELATED APPLICATION

This application incorporates by reference and claims priority to European Patent Application No. 23382085.1, filed Feb. 1, 2023.

### TECHNICAL FIELD

The invention refers to a network of optical fiber sensors and a method for monitoring the structural health of a composite cryogenic liquid hydrogen fuel tank, especially in aircraft applications, that uses such network of optical fiber sensors. It is also applicable to the safety of many other components of the hydrogen distribution, such as pipes, pumps or valves inside the aircraft.

### BACKGROUND

The aircraft industry is answering to the demand of sustainable transports by considering hydrogen as the clean fuel for future passenger aircraft.

As a fuel, hydrogen (H₂) has the benefit of an extremely high specific energy. However, its low specific density counteracts resulting in a relatively low volumetric energy density. To compensate this issue, it is required to store the H₂ in liquid form at low pressure—around 1 bar—but in a deeply cryogenic state—20 K—to minimize storage volume and to avoid H₂ boiling point.

Carbon Fiber Reinforced Polymers (CFRP) are one of the expected material families being investigated for use in the fuel tanks to try to improve the relatively high-weight solution of metallic alloys. CFRPs have high strength and stiffness, high toughness, and good chemical resistance. However, due to the frequent extreme cryogentank, hermo-mechanical loading cycles on this scenario, two main damage modes can arise in the CFRP tank which are matrix micro-cracking and inter-laminar delaminations. Additionally, extensive crack networks may form through the tank wall that can lead to gradual H₂ leaks as a consequence of the increased laminate permeability and the small molecular size of H₂. This last aspect is crucial and would impact severely to the safety of the tank structure, the thermal isolation of the tank (cryo concept of the tank structure comprises inner and outer walls separated by a vacuum core) and last but not least will be economically also rejected because of fuel escape.

In order to mitigate the permeation issue, the use of CFRP materials for H₂ tanks requires barrier materials to the permeation (liners) to be added. These layers are to be applied on outer or inner surfaces of the inner CFRP tank. The barrier materials are not a complete solution to avoiding H₂ permeability issues because these barrier materials have issues regarding uniformity, application procedures, and in-service conditions.

Summarizing, at present the detection in composite components of critical damage accumulation, in the form of micro-cracking and delamination, is a difficult and time consuming task up to extend that due to crack closure or because of thick laminate sections, these types of damage may be undetectable by conventional non-destructive methods such as ultrasound or X-ray scanning techniques.

Micro-cracking and consequent increasing of the laminate permeability is micro and macroscopically manifested by the formation of gas leakage paths and also by the alteration of the mechanical properties of the material.

Besides, the prediction of these damage modes and how to determine their influence on the structural performance of the components and material properties like permeability remains today as an outstanding issue to be solved.

### SUMMARY

The invention may be embodied to provide a network of optical fiber sensors and a method for monitoring the structural health of a composite cryogenic liquid hydrogen fuel tank that allows the indirect detection of the micro-cracks network in in-service conditions in a simple way, in order to control the structural integrity of the tank.

The invention may be embodied to provide a network of optical fiber sensors suitable to be installed in a hydrogen fuel tank, wherein the optical fiber sensors are connected forming a network and are placed in the tank and are configured to be able to continuously and simultaneously measure these physical variables (physical parameters): temperatures, strains and pressures or to detect H₂, by converting modified light properties into the corresponding physical variable.

The invention may also be embodied to provide a method for monitoring the structural health of a composite cryogenic liquid hydrogen fuel tank, that comprises the following steps:
A) determination of the permeability curves k=f(t) for a material configuration of the tank as a function of service conditions, such as measured physical variables (parameters), and determination of the critical permeability value k for the material configuration,
B) real in-service test for a tank with a specific material configuration including continuous measurement of the following parameters by optical fiber sensors integrated in the network:
1. distribution of temperatures inside the inner tank,
2. distribution of temperatures inside the intermediate chamber,
3. distribution of temperatures on the outer tank,
4. strain in several locations of the tank, and
5. pressure inside the tank and inside the intermediate chamber,
analysis of the evolution and correlations of the measured parameters along in-service time;
determination of the threshold level of micro-cracks and estimation of the permeability status of the tank, comparing a permeability value k with the critical permeability value k, and
decision about maintenance or repair of the tank based the comparison of k to the critical k value.

The network of optical fiber sensors monitoring all the parameters simultaneously enables the study correlation and analysis of the physical events taking place in the tank over the life of the tank.

The combination of the analysis of the simultaneous parameters increases the sensitivity of the microcrack diagnosis, facilitates the redundancy of the measurements and minimizes the presence of those false alarms produced by magnitude changes in some parameters of the same order as measurement uncertainties.

Other characteristics and advantages of the present invention will be clear from the following detailed description of several embodiments illustrative of its object in relation to the attached figures.

### BRIEF DESCRIPTION OF DRAWINGS

FIG. 1 shows a hydrogen fuel tank with a network of optical fiber sensors of the invention.

FIG. 2 shows a platform that receives multiple channels, each channel corresponding to a sensor type.

FIG. 3 is a graph showing different permeability curves as a function of in-service conditions, and the point of critical permeability.

FIG. 4 is a flow chart describing the in-service steps of the method of the invention.

### DETAILED DESCRIPTION

The network of optical fiber sensors of the invention is suitable to be installed in a hydrogen fuel tank 1, and the optical fiber sensors are connected forming a network with strain sensors 11, temperature sensors 12 and H₂ sensors 15, configured to be able to continuously and simultaneously measure these physical variables: temperatures, strains and pressures or to detect H₂, by converting modified light properties into the corresponding physical variable.

In another embodiment the network comprises additional optical fiber sensors (acceleration sensors 13) configured to be able to continuously and simultaneously measure acceleration.

In another embodiment the network comprises additional optical fiber sensors (oxygen O₂ sensors 14) configured to detect O₂.

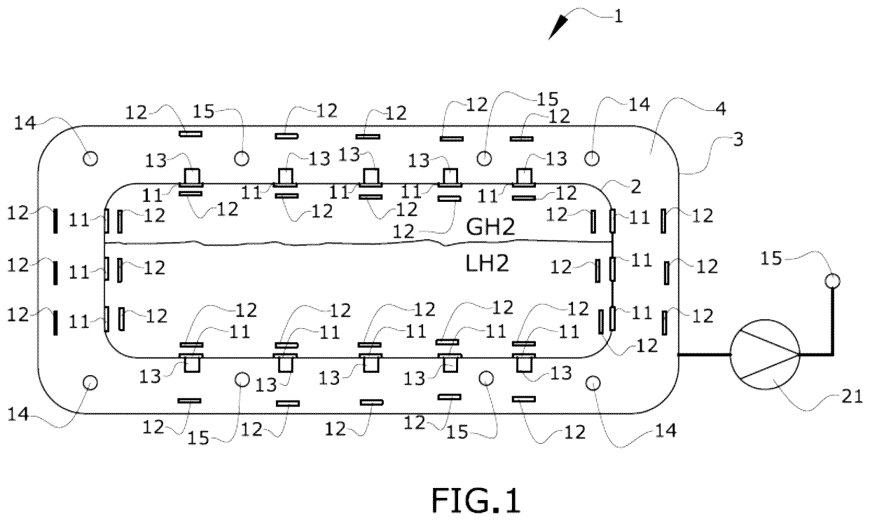

One example of a network of optical fiber sensors of the invention can be seen in FIG. 1, which shows a hydrogen fuel tank 1 instrumented with a network of optical fiber sensors (OFS), in which there are strain sensors 11, temperature sensors 12, acceleration sensors 13, O₂ sensors 14 and H₂ sensors 15. These sensors are configured to be able to continuously and simultaneously measure these physical variables: temperatures, strains, pressures and accelerations) or to detect O₂ and H₂, by converting modified light properties into the corresponding physical variable.

The hydrogen fuel tank 1 can be a single wall tank.

In another embodiment (as shown in FIG. 1), the hydrogen fuel tank 1 is a composite cryogenic liquid hydrogen fuel tank of the type comprising an inner tank 2, an outer tank 3 and an intermediate chamber 4 between the inner tank 2 and the outer tank 3. In this embodiment the optical fiber sensors are placed in the inner tank 2, in the intermediate chamber 4 and in the outer tank 3.

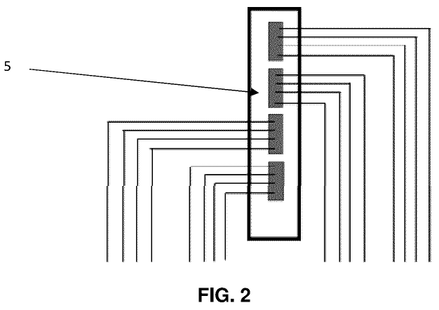

FIG. 2 shows a platform 5 that receives multiple channels working in parallel. Each channel corresponds to a sensor type (e.g. one channel for temperature sensors 12, another channel for strain sensors 11, etc.). In this way the sensors can be managed by the platform 5, acting as a multifunctional optical fiber sensors platform that comprises an array of optical channels wherein the modified light properties, such as wavelength, are properly converted into physical measurements, like temperature, strain, load, acceleration or pressure, or gas detection.

The optical fiber sensors can be of many kinds, for instance, luminescent optical fiber sensors, fiber Bragg grating sensors or backscattering sensors.

The main factors affecting the onset, growth and density of micro-cracking of cryogenic composite tanks can be classified into the main groups:
a) On the one hand, those factors related to the material such as the individual ply thickness, thickness laminate, lay-up, material properties (fiber and matrix) and presence of manufacturing defects such as voids, porosity or rich resin areas.
b) On the other hand, external factors such as the load, pressure or thermal stresses related to the cooling/warming rate and the number of fueling/refueling cycles that repeatedly exposed the tanks walls to thermal cycles between −250° C. to room temperature.

The micro-cracking of the material and the application of liner materials as barrier materials against H₂ permeation through the inner vessel can be considered two of the most important factors when studying the H₂ permeability through the tank. Thus, the first step of this invention is the previous characterization of the selected material configuration of the tank (including liner), by cryogenic cycle tests combined with full experimental investigation by such as by non-destructive testing (NDT). These tests will enable to estimate a quantitative relationship between the micro-cracking, crack opening displacement and global material permeability decrease along the in-service time and measured by the optical fiber sensors (temperature, strain, pressure and vibration modes). This relationship assists in the prediction of the onset of the critical density of micro-cracking and delaminations length.

The temperature measurements inside the tank are done by temperature sensors 12 that can be Fiber Bragg Grating sensors (FBG sensors). This type of sensor has demonstrated excellent capability to measure temperature in conventional aerospace temperature ranges (−60 to 300° C.) but reduce drastically the temperature sensitivity at H₂ cryo temperatures. This invention includes modified fiber Bragg grating sensors able to measure the temperature evolution from room temperature to cryo conditions. The material of the fiber coating, length of the grating and overall, the capsulated process of the sensor are specially done so that the final sensor configuration present enough sensitivity, robustness and stability over the complete temperature range of this application. This temperature will be uniformly distributed over the complete tank monitoring the complete in-service operation. The temperature history, cooling/warming rate and the number of refueling cycles is thereby precisely accounted.

The strain measurement of the tank, related to the internal stresses due to the pressurization state and the thermal cycles conditions, are done by strain sensors 11 that can also be fiber Bragg grating sensors. Again FBG sensors have demonstrated excellent capability to measure strain in conventional aerospace conditions but in cryo conditions the capability of the sensors is enormously impacted due to peak splitting of the spectrum. This phenomenon related to the inevitable transversal stress on the sensors because of the strong temperature gradient (around 300 K) is also corrected by a special design, configuration and integration procedure of the sensor inside the tank. The design consists of introducing the sensing length of the fiber inside a metallic or polymeric capillary so that the transmission of the strain from the substrate to the sensing fiber is purely done by longitudinal stress and not transversal stress. The capillary is precisely chosen in terms of diameter and length respect to the fiber grating so that it will not exist contact between the capillary and fiber in the complete temperature range despite the different thermal contraction of capillary and fiber materials. The adhesive to join the fiber to the material of the tank is only applied on the two edges of the fibers adjacent to the grating and the external surface of the capillary. The edges of the capillary are also cut very carefully by electro erosion process to avoid the release of sharped areas that could cut damage the fiber when working in cyclic stress. All the fiber edges and capillary are finally covered by aluminum tape to minimize the contact of gases with the sensor. Therefore, the final result of this sensor configuration results in a spectrum peak that is unaltered and therefore able to measure the strain when tensile or compressed in similar conditions to room temperature.

Since the micro cracking also leads to a multidirectional reduction in stiffness of the whole laminate, the monitoring and control of the evolution of the strain in multi-directions together with the measurement of the temperature and pressure inside the tank will support of the determination of an empirical factor related to the prediction of the level of micro cracks inside the material. The use of distributed FBG sensors in a unique optical fiber will enable detecting the stiffness changes due to the microcracking when comparing different locations and direction of the tank with respect to a pristine status.

The permeation of H₂ through the thickness of the tank wall, and subsequent expansion within the intermediate chamber 4 will be also double detected by:
A) FBG optical fiber differential pressure that is integrated inside the tank and inside the volume between inner and outer vessels, where the insulation/vacuum takes place. These sensors are installed in an elastic membrane that is linearly deflected when differential pressure changes. The geometry and mechanical properties of the material of the membranes are carefully selected in function of the differential pressure changes to be measured. The temperature effect is compensated by the temperature sensors previously described.
B) H₂ leak sensors located in the volume of the intermediate chamber 4 and also based on FBG sensors. The sensors have sensitivity to the H₂ concentration and therefore make a warming when the gas concentration is higher than an established critical value.
C) Additionally, the temperature sensors 12 inside the volume of the intermediate chamber 4 and on the outer tank also based on FBG sensors will assist to the leak detection by the gradual and progressive detection of the lower temperatures in the intermediate chamber 4 and outer tank surface since the H₂ leaks will affect the temperature in the intermediate chamber 4 and the insulation effectiveness by degrading vacuum. This H₂ molecules increase the pressure and also the thermal conductivity of the double walled insulated tank.

The vibration modes of the tank can also be measured by acceleration sensors 13, like modified FBG sensors. The use of multiple optical fiber accelerometers located in different locations of the tank will add accuracy and redundancy to this tool. The fiber optical accelerometers are prepared in a special casing that is in turn fit to the tank so that the vibrations of the structure can be measured. The sensor and casing will be adapted to get maximum sensitivity and resolution for the expected frequency range. These sensors along with an external precise mechanical hammer that include also a synchronized FBG sensor sensitive to the impact to the tank will enable to determine the modal shapes of the Liquid H₂ tank. The correlation between the FBG sensors installed on the tanks with the FBG sensor installed on the hammer enable to calculate the modal forms of the tanks. Since the natural frequencies of the tank are in fact function of the rigidity of the tank (and also the mass), these sensors will allow also to measure the variation of the rigidity due to the micro-cracks when compared with a pristine state of the tank. During the operational modal analysis it will be necessary to control the mass of H₂ inside the tank since this also influences the modal shapes on the tank. This could be done by other level sensors based on temperature distribution (that could be the same described previously located in the proper configuration or even ultrasound sensors).

O₂ detection sensors 14, which can also be based on FBG sensors and located in the intermediate chamber, are installed, since the presence of this gas with H₂ leaks is a serious hazard if the mixture reaches the critical explosive limit.

The combination and measurement of the causes-effects by all these optical fiber sensors in correlation with the model previously determined by experimental tests will enable to determine the evolution of the tank and the establishment of in-service critical status of the tank.

The method for monitoring the structural health of a composite cryogenic liquid hydrogen fuel tank 1 of the invention comprises the following steps:
A) determination of the permeability curves k=f(t) for a material configuration as a function of service conditions, and determination of the critical k value for the material configuration,
B) real in-service test for a tank 1 with a specific material configuration including continuous measurement of the following parameters (variables) by optical fiber sensors integrated in the network:
   distribution of temperatures inside the inner tank,
   distribution of temperatures inside the intermediate chamber,
   distribution of temperatures on the outer tank,
   strain in several locations of the tank, and
   pressure inside the tank and inside the intermediate chamber,
      analysis of the evolution and correlations of the measured parameters along in-service time;
   determination of the threshold level of micro-cracks and estimation of the permeability status of the tank 1, comparing k with the critical k value, and
   decision about maintenance or repair of the tank 1 based on the comparison of k with the critical k value.

In step a), the determination of the permeability curves k=f(t) for a material configuration as a function of service conditions, and the determination of the critical k value for the material configuration can be done after preliminary tests that comprise:
select a material configuration for a test sample of the tank 1,
prior verification by non-destructive testing that the sample does not present porosity, delaminations, excess resin or any other defect affecting its mechanical properties,
mechanical characterization tests to determine the modulus of elasticity and mechanical strength under initial conditions without exposure of the material to gases,
integration of a network of optical fiber sensors of claim 1 in the sample,
submitting the sample to test conditions that are representative of the actual application in terms of stiffness and mechanical pressure cycles,
installation of a vacuum pump 21 outside the tank and H₂ detecting system, so that there are two separate pressure and concentration zones: H₂ at a given pressure and vacuum required to maintain thermal stability in the tank 1,
realization of cryogenic temperature cycles,
the fiber optic sensors monitor the evolution of strain and temperature in the sample during tests,
after several test cycles the sample is disassembled and mechanically tested to evaluate the decrease in mechanical properties,
determinate permeability curves k=f(t) for the tested material configuration as a function of service conditions,
determine a critical k value for the tested material configuration, and
repetition of the above steps for each material configuration.

In another embodiment of the method, it can additionally comprise the detection of H₂ by optical fiber sensors placed inside the intermediate chamber 4 and/or outside the tank 1 and integrated in the network:

In another embodiment of the method, it additionally comprises the detection of O₂ by optical fiber sensors placed inside the intermediate chamber 4 and integrated in the network:

In another embodiment of the method, it additionally comprises the continuous measurement of vibration modes by different optical fiber sensor accelerometers at different locations of the tank (1) integrated in the network.

In another embodiment of the method, the sample incorporates a tomography inspection camera to study the evolution of cracks simultaneously.

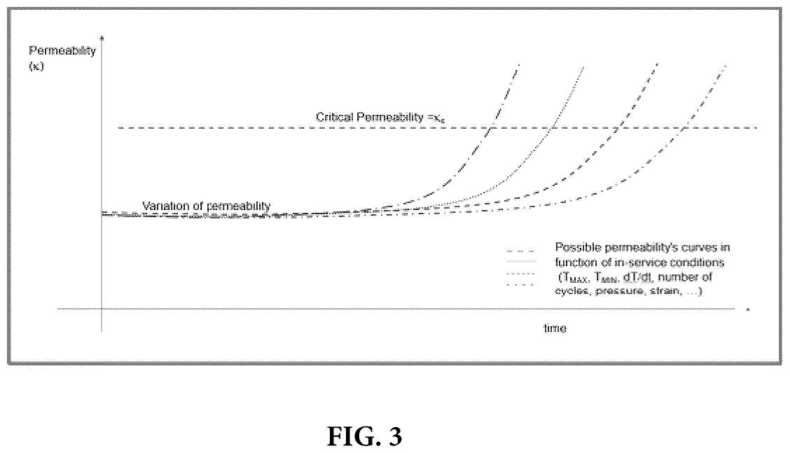

FIG. 3 is a graph showing possible permeability curves as a function of in-service conditions (Tmax, Tmin, dT/dt, number of cycles, pressure, strain, etc.). It also shows the point of critical permeability, and its intersection with the permeability curves. These intersections indicate the time to take maintenance actions on the tank 1 (replacement, repair, etc.) for each permeability curve.

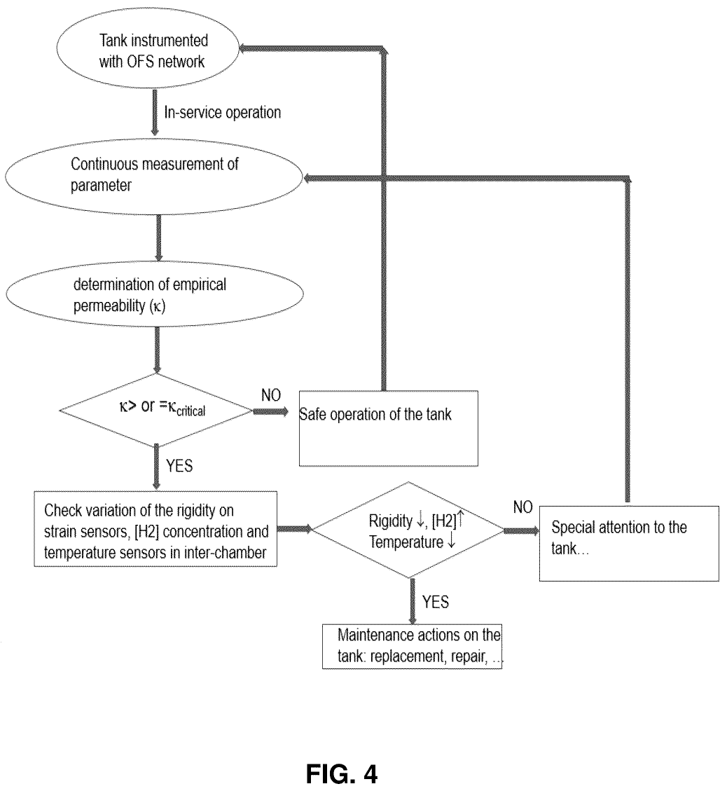

FIG. 4 is a flow chart describing the in-service steps of the method of the invention. After the comparison between the permeability k with the critical permeability kc, the variation of the rigidity on strain sensors, the H₂ concentration and the temperature of the temperature sensors in the intermediate chamber 4 can be checked, in order to decide to take maintenance actions on the tank, such as its replacement or repair.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless this application states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A network of optical fiber sensors in a hydrogen fuel tank comprising:
the optical fiber sensors are connected to form the network and are in the hydrogen fuel tank, and
the optical fiber sensors are configured to continuously and simultaneously measure physical variables of the hydrogen fuel tank including one or more of: temperatures, strains and pressures or detect H₂, wherein the optical fiber sensors convert modified light properties into the corresponding physical variable.

2. The network according to claim 1, wherein the hydrogen fuel tank is a single wall tank.

3. The network according to claim 1, wherein the hydrogen fuel tank is a composite cryogenic liquid hydrogen fuel tank comprising an inner tank, an outer tank, and an intermediate chamber between the inner tank and the outer tank,
wherein the optical fiber sensors are in the inner tank, in the intermediate chamber and in the outer tank.

4. The network according to claim 1, further comprising additional optical fiber sensors configured to continuously and simultaneously measure acceleration.

5. The network according to claim 1, further comprising additional optical fiber sensors configured to detect oxygen (O₂).

6. The network according to claim 1, wherein the optical fiber sensors are luminescent optical fiber sensors.

7. The network of optical fiber sensors according to claim 1, wherein the optical fiber sensors include fiber Bragg grating sensors.

8. The network of optical fiber sensors according to claim 1, wherein the optical fiber sensors include backscattering sensors.

9. A method for monitoring a structural health of a composite cryogenic liquid hydrogen fuel tank including an inner tank, an outer tank and an intermediate chamber between the inner tank and the outer tank, wherein optical fiber sensors are in the inner tank, the outer tank and in the intermediate chamber, the method comprising:
determining permeability curves (k=f(t)) for a material configuration of the tank as a function of service conditions of the cryogenic liquid hydrogen tank;
determining a critical k value for the material configuration;
conducting in-service tests of the cryogenic liquid hydrogen fuel tank by continuously and simultaneously measuring with the optical fiber sensors values of physical parameters indicative of the cryogenic liquid hydrogen fuel tank, wherein the physical parameters include:
distribution of temperatures in the inner tank,
distribution of temperatures in the intermediate chamber,
distribution of temperatures on the outer tank,
strains at locations on the inner and/or outer tank, and
pressure in the inner tank and in the intermediate chamber;
determine a permeability status (k) for the cryogenic liquid hydrogen fuel tank, by analyzing, using the permeability curves, an evolution of the values of the physical parameters during an in-service period of the cryogenic liquid hydrogen fuel tank;
determine a threshold level of micro-cracks in the cryogenic liquid hydrogen fuel tank by comparing the permeability status (k) to the critical k value, and
determining, based on the threshold level of micro-cracks, whether to perform a maintenance action on the cryogenic hydrogen fuel tank or to replace the cryogenic hydrogen fuel tank.

10. The method of claim 9, wherein the determination of the permeability curves k=f(t) includes:
selecting a sample of the material configuration of the cryogenic liquid hydrogen tank,
verifying by non-destructive testing that the sample does not present porosity, delaminations, excess resin or other defects affecting mechanical properties of the sample,
conducting mechanical characterization tests on the sample to determine a modulus of elasticity and a mechanical strength of the sample under initial conditions without exposure of the material to gases,
applying a network of optical fiber sensors to the sample,
testing, using the network, the sample under test conditions representative of service conditions of the cryogenic liquid hydrogen tank, wherein the test conditions include stiffness and mechanical pressure cycles representative of cycles of the service conditions,
using a vacuum pump outside the cryogenic liquid hydrogen tank and H₂ detecting system, so that there are two separate pressure and concentration zones H₂ at a given pressure and vacuum required to maintain thermal stability in the tank,
realization of cryogenic temperature cycles,
using the network of fiber optic sensors to monitor an evolution of strain and temperature in the sample during several test cycles during the testing,
after the several test cycles mechanically testing the sample to measure changes in mechanical properties of the sample,
generate one of the permeability curves k=f(t) for the sample after the testing and based on the changes in the mechanical properties, and
repeating the steps for each material configuration of the cryogenic liquid hydrogen tank.

11. The method of claim 9, further comprising detection of hydrogen (H₂) by the optical fiber sensors.

12. The method of claim 9, further comprising detection of oxygen (O₂) by the optical fiber sensors.

13. The method of claim 9, further comprising continuously measuring vibration modes by different ones of the optical fiber sensors at various locations in the inner tank, the outer tank and in the intermediate chamber, wherein the different ones of the optical fiber sensors are configured to sense acceleration.

14. The method of claim 11, further comprising performing a tomography inspection with a camera capturing images of the inner tank and the outer tank, and
analyzing the images to show an evolution of cracks in the inner tank and the outer tank over the in-service period of the cryogenic liquid hydrogen tank.
